(19) United States
(12) Patent Application Publication
(10) Pub. No.: US 2010/0154944 A1
(43) Pub. Date: Jun. 24, 2010

(54) WHEELED VEHICLE ENCLOSURE

(76) Inventor: Dan M. Sheldon, Cornelius, OR (US)

Correspondence Address: KOLISCH HARTWELL, P.C., 200 PACIFIC BUILDING, 520 SW YAMHILL STREET, PORTLAND, OR, 97204, US

(21) Appl. No.: 12/639,643

(22) Filed: Dec. 16, 2009

Related U.S. Application Data
(63) Continuation of application No. 11/267,831, filed on Nov. 4, 2005, now abandoned.
(60) Provisional application No. 60/625,310, filed on Nov. 4, 2004.

(51) Int. Cl. B62J 19/00

(52) U.S. Cl. 150/167

(57) ABSTRACT

A wheeled vehicle enclosure system includes a body constructed to enclose a wheeled vehicle. The body is made from a material that is synthetic, durable, flexible, and weather-resistant . Wheeled-vehicle-receiving structure is constructed to allow the body to be fitted around the wheeled vehicle, and a closer is coupled to the body adjacent the wheeled-vehicle-receiving structure and constructed to close the bicycle-receiving structure. The closer may be formed as a zipper-closer subsystem. Enclosure-tightening structure produces a preselectively tighter fit of the system around the wheeled vehicle. The wheeled-vehicle enclosure system may be used for bicycles or other wheeled vehicles.

### CROSS-REFERENCE TO RELATED APPLICATIONS

This application is a continuation of U.S. patent application Ser. No. 11/267,831, filed Nov. 4, 2005 and entitled WHEEL VEHICLE ENCLOSURE, which application claims priority to U.S. Provisional Patent Application Ser. No. 60/625,310, filed Nov. 5, 2004, and entitled WHEELED VEHICLE ENCLOSURE, which is incorporated herein by reference.

### TECHNICAL FIELD

The field of the invention relates to systems and methods for covering wheeled vehicles such as bicycles.

### SUMMARY OF THE INVENTION

The invention may be thought of as a wheeled vehicle enclosure system that includes a body constructed to enclose a wheeled vehicle, such as a bicycle. The body is made from a material that is synthetic, durable, flexible, and weather-resistant. Wheeled-vehicle-receiving structure is constructed to allow the body to be fitted around the wheeled vehicle, and a closer is coupled to the body adjacent the wheeled-vehicle-receiving structure and constructed to close the bicycle-receiving structure. The closer may be formed as a zipper-closer subsystem. Enclosure-tightening structure produces a preselectively tighter fit of the system around the wheeled vehicle.

### BRIEF DESCRIPTION OF THE DRAWINGS

FIG. 1 is a photograph showing a front view of a preferred embodiment of the invention being used to enclose a bicycle.

FIG. 2 is a photograph showing a back view of a preferred embodiment of the invention.

FIG. 3 is a photograph showing a side view of a preferred embodiment of the invention.

FIG. 4 is a photograph showing a close-up side view of the view shown in FIG. 3.

FIG. 5 is a photograph showing a front view like that shown in FIG. 1, but wherein the invention is mounted on a hitch that is attached to a different vehicle.

FIG. 6 is a photograph showing a side view of a preferred embodiment of the invention mounted on an alternate hitch that holds the bicycle in a substantially vertical orientation.

FIG. 7 is a photograph showing a close-up view of the view shown in FIG. 6.

### DETAILED DESCRIPTION

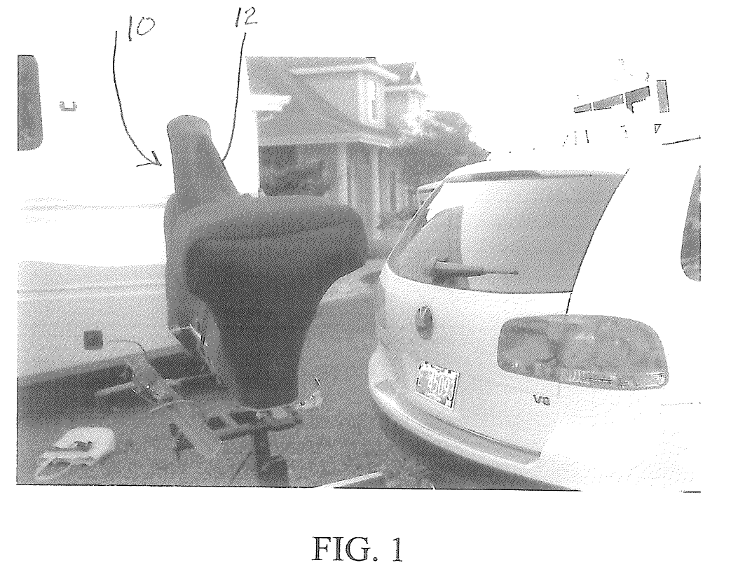

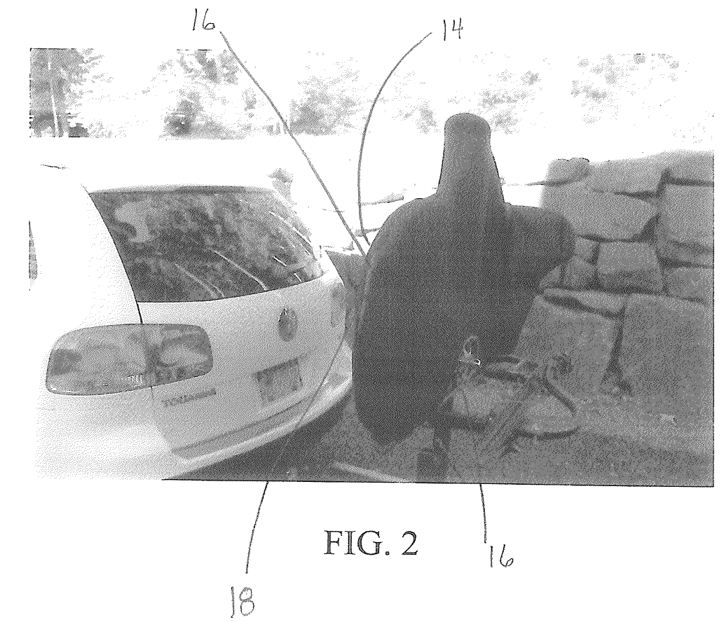

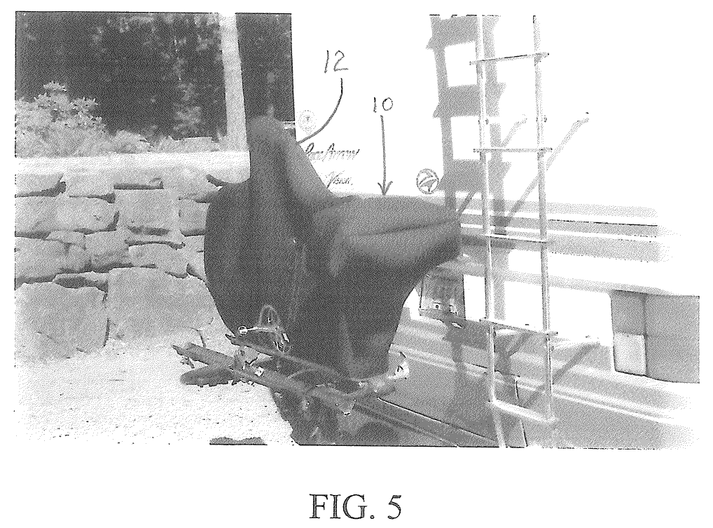

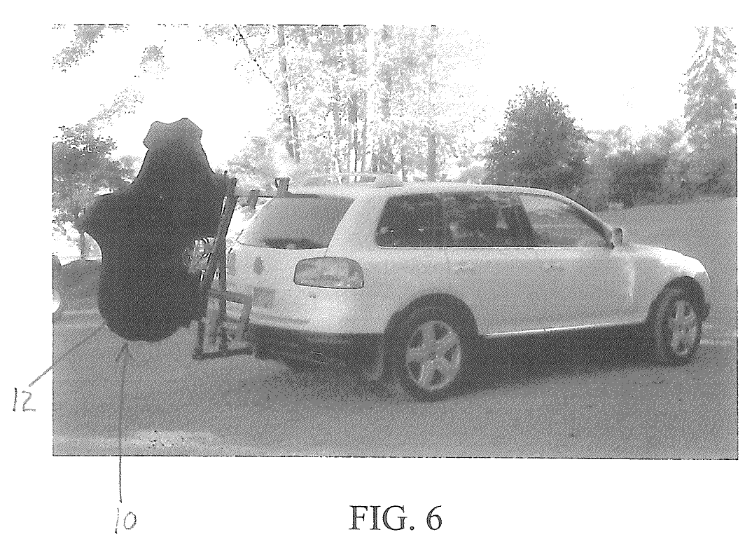

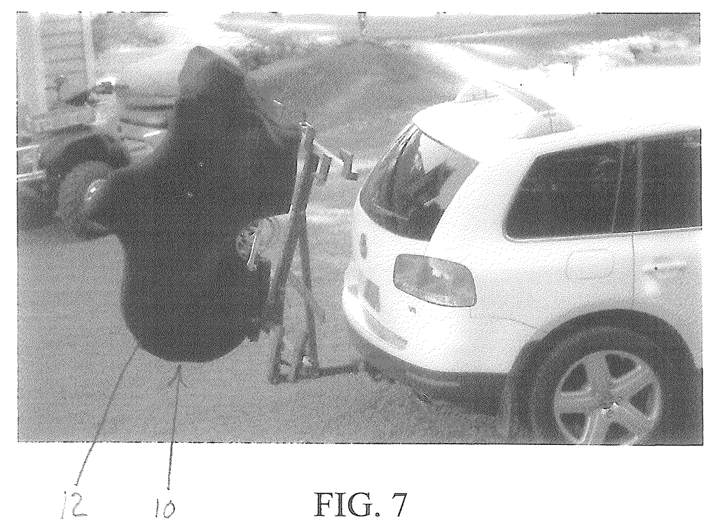

In FIGS. 1-7 there are photographs showing several views of the wheeled vehicle enclosure invention. The invention may be thought of as a bicycle enclosure 10, and that version of the invention is shown in the figures. The enclosure includes a body 12 which may be made from any suitable material, but is preferably made from a synthetic, durable, flexible, weather-resistant material such as that sold under the trademark NEOPRENE™. Referring to FIG. 2, there is shown a side region 14 with bicycle-receiving structure 16 that allows the bicycle enclosure to be opened at one end, thereby accommodating placement of the enclosure around the bicycle. Structure 16 may take the form of one or more openings formed in body 12. Put another way, the bicycle can be placed within the bicycle enclosure through opening 16. A closer 18 is also coupled to the body for closing the bicycle-receiving structure. The closer may take the form of a zipper-closer subsystem. Bicycle enclosure system 10 is preferably designed to enclose substantially the entire bicycle. However, as shown in the figures, it may be desirable to enclose the bicycle less the front wheel for purposes of attachment to various commercially available bicycle carriers that are attachable to automobiles, trucks and recreational vehicles.

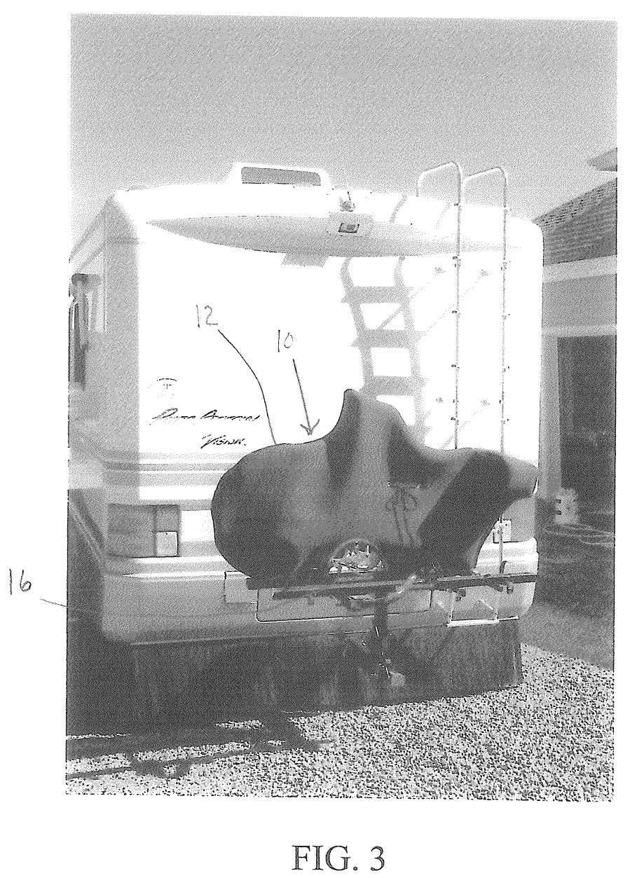

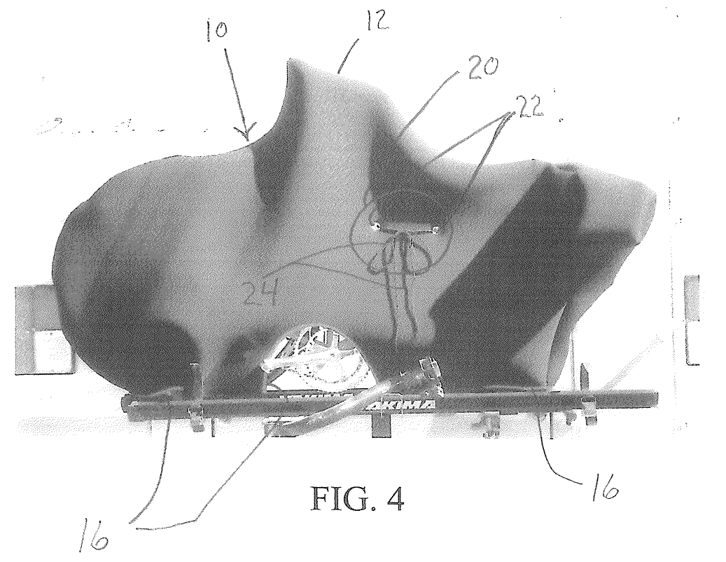

Referring to FIGS. 3-7, there is also shown enclosure-tightening structure 20 to produce a preselectively tighter fit of the enclosure about the bicycle. Referring to FIG. 4, the enclosure-tightening structure may take the form two pairs of openings (one pair shown at 22 and the other undepicted but formed in the side of body 12 that is facing opposite the side shown in the photograph) formed in opposing sides of the enclosure for allowing tie structure 24, which may be formed as a string or rope, to be fed through and knotted as a way of pulling the opposing sides together. Tie structure 24 allows for a tighter fit of the enclosure around the bicycle.

As noted above, the version of the enclosure shown in the figures is designed for placement around a bicycle that has had its front wheel removed. However, the enclosure could also be made to fit around both the front and rear wheel if desired. The figures also show that the enclosure is designed for placement around a bicycle that has been mounted on typical bicycle carriers for vehicles. Those bicycle carriers may be rear-mounted to the back of cars or recreational vehicles. However, the enclosure of the invention may also be used for other types of vehicle carriers not shown in the figures (such as ceiling-mounted vehicle carriers or so-called roof racks).

By providing the enclosure of the invention, the user of a bicycle can safely and effectively cover it during ground transportation of the bicycle to a desired location. The enclosure protects the bicycle from unwanted and possibly harmful dirt, gravel, and weather such as rain or snow. While the figures show only a bicycle enclosure, the idea of the invention is to use it for any wheeled vehicle that will be carried (or even towed) by another vehicle.

The specific embodiments of a wheeled vehicle enclosure system as disclosed and illustrated herein are not to be considered in a limiting sense as numerous variations are possible. The subject matter of this disclosure includes all novel and non-obvious combinations and subcombinations of the various features, elements, functions and/or properties disclosed herein. No single feature, function, element or property of the disclosed embodiments is essential. The following claims define certain combinations and subcombinations which are regarded as novel and non-obvious. Other combinations and subcombinations of features, functions, elements and/or properties may be claimed through amendment of the present claims or presentation of new claims in this or a related application. Such claims, whether they are different, broader, narrower or equal in scope to the original claims, are also regarded as included within the subject matter of the disclosure.

I claim:

1. A wheeled vehicle enclosure system, comprising:
a body constructed to enclose a wheeled vehicle, wherein the body is made from a material that is synthetic, durable, flexible, and weather-resistant;
wheeled-vehicle-receiving structure constructed to allow the body to be fitted around the wheeled vehicle; and
a closer coupled to the body adjacent the wheeled-vehicle-receiving structure and constructed to close the bicycle-receiving structure.

2. The wheeled vehicle enclosure system of claim 1, wherein the closer is a zipper-closer subsystem.

3. The wheeled vehicle enclosure system of claim 1, further including enclosure-tightening structure to produce a preselectively tighter fit of the system around the wheeled vehicle.

4. A bicycle enclosure system, comprising:
a body constructed to enclose a bicycle, wherein the body is made from a material that is synthetic, durable, flexible, and weather-resistant;
bicycle-receiving structure constructed to allow the body to be fitted around the bicycle; and
a closer coupled to the body adjacent the wheeled-vehicle-receiving structure and constructed to close the bicycle-receiving structure.

5. The bicycle enclosure system of claim 4, wherein the closer is a zipper-closer subsystem.

6. The bicycle enclosure system of claim 4, further including enclosure-tightening structure to produce a preselectively tighter fit of the system around the bicycle.
